(19) United States
(12) Patent Application Publication
(10) Pub. No.: US 2008/0184812 A1
(43) Pub. Date: Aug. 7, 2008

(54) AIR FLOW MEASUREMENT DEVICE

(75) Inventors: Neng-Yu Pan, Tu-Cheng City (TW); Ya-Ping Lin, Tu-Cheng City (TW)

Correspondence Address: PATENTTM.US, P. O. BOX 82788, PORTLAND, OR, 97282-0788, US

(73) Assignee: APEX MEDICAL CORP., Tu-Cheng City (TW)

(21) Appl. No.: 11/671,228

(22) Filed: Feb. 5, 2007

(51) Int. Cl. G01F 1/34

(52) U.S. Cl. 73/861.42

(57) ABSTRACT

An air flow measurement device includes an air pipe securely formed inside the cylindrical tube, a first measuring tube securely formed inside the cylindrical tube and having a first open end located at an inner side face of the air pipe so as to measure radial pressure of air flowing through the air pipe and a second open end extending out of the cylindrical tube. An L shaped measuring tube is securely formed inside the cylindrical tube and has a first open end located at the inner side face of the air pipe so as to measure axial pressure of air flowing through the air pipe and a second open end extending out of the cylindrical tube.

### BACKGROUND OF THE INVENTION

1. Field of the Invention

The present invention relates to an air flow measurement device, and more particularly to an air flow measurement device to maximize difference in the air flow so as to allow the oxygen providing machine to adjust oxygen providing volume.

2. Description of the Prior Art

A person unable to breath normally has to depend on the oxygen providing machine to provide the necessary oxygen to help breath normally or sustain living. However, because the exhale rate of the user is different in the time when the user is awake and in the time when the user is asleep. Therefore, when the user is awake, the oxygen providing machine needs to provide lots of oxygen to help the user. When the user is asleep, due to low oxygen consumption, the oxygen providing machine needs to be adjusted to provide less oxygen so as not to disturb the user. In order to make the necessary adjustment, the oxygen providing machine is provided with a monitoring device to monitor the user's exhale rate. Therefore, the oxygen providing volume of the oxygen providing machine depends from the monitoring result.

U.S. Pat. No. 6,324,917 issued to Mack et. al. on the date of Dec. 4, 2001 disclosed a flow measurement device which has an air pipe with two measuring tubes vertically extending from the air pipe. When air flows through the air pipe, the two measuring tubes are able to measure the pressure difference at two different points such that based on the air pressure difference, the oxygen providing machine is able to make the instant and necessary adjustment. U.S. Pat. No. 6,164,142 issued to Dimeff on Dec. 26, 2000 also disclosed an air pipe with two vertically extending tubes. The two extending tubes are able to detect air pressure at two distinct positions and the air pressure is sent to the oxygen providing machine to determine if the adjustment of oxygen providing volume is necessary. It is also clear from the previous two U.S. patents that based on the air pressure difference detected by the two vertically extending tubes at two positions, the air pressure difference is not able to provide sufficient information to the oxygen providing machine to make the instant adjustment. It is because the two tubes detect only axial pressure of the air flow when passing through the air pipe. As well known in the art, air flow in an air pipe is greatly influenced by laminar effect. The laminar effect causes the air pressure to fluctuate. As a result, this type of air flow measurement technique not only is inaccurate, the oxygen providing machine would not receive the necessary information to make the instant adjustment in oxygen providing volume.

To overcome the shortcomings, the present invention tends to provide an improved air flow measurement device to mitigate the aforementioned problems.

### SUMMARY OF THE INVENTION

The primary objective of the present invention is to provide an improved air flow measurement device to accurately measure air pressure and then maximize the air pressure difference to allow the oxygen providing machine to make the necessary adjustment in oxygen providing volume.

Another objective of the present invention is that the air flow measurement device is able to smooth the air flowing through the air pipe so as to have the air flow measurement accurately detected.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the air flow measurement device of the present invention;

FIG. 2 is a perspective view of the air flow measurement device in a different angle relative to that shown in FIG. 1; and

FIG. 3 is a cross sectional view of the air flow measurement device by the line 3-3 in FIG. 1.

### DETAILED DESCRIPTION OF THE PREFERRED EMBODIMENT

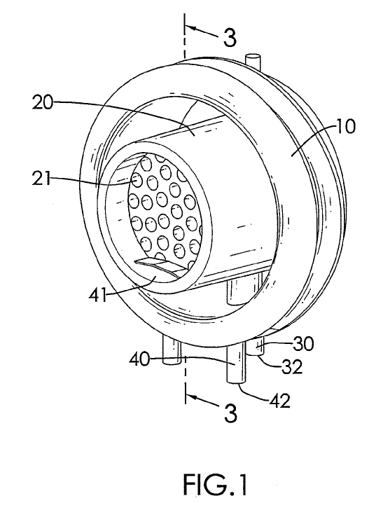

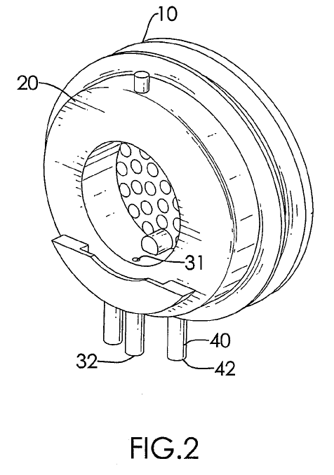

With reference to FIGS. 1 and 2, it is noted that the air flow measurement device in accordance with the present invention includes a cylindrical hollow tube (10), an air pipe (20) firmly formed inside the hollow tube (10), a vertical measuring tube (30) and two L-shaped measuring tubes (40).

The air pipe (20) has multiple air passages (21) formed inside the air pipe (20) and communicating with the hollow tube (10). The vertical measuring tube (30) has a first open end (31) located at an inner side face of the air pipe (20) to be vertical to the air passages (21) and a second open end (32) directly extending downward and out of the hollow tube (10). Each of the L shaped measuring tube (40) has a first open end (41) located at a position parallel to the air passages (21) and a second open end (42) vertical to the air passages (21) and communicating with ambient air.

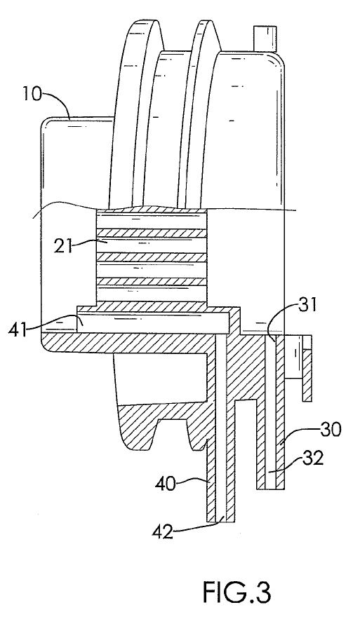

With reference to FIG. 3, it is noted that the first open end (31) of the vertical measuring tube (30) is able to measure radial pressure of the air flow passing through the hollow tube (10) and the first open end (41) of each L-shaped measuring tube (40) is able to measure axial pressure of the air flow passing through the air passages (21). Also, the position of the first open end (31) of the vertical measuring tube (30) is located before the air pipe (20). However, the position of the first open end (41) of the L-shaped measuring tube (40) is located after the air passages (21). As well known in the art of fluid dynamics, air moving speed in a narrow space is larger than the air moving speed in a large space. Therefore, measuring the air pressure by the first open end (41) of the L-shaped measuring tube (40) is greatly different from the air pressure measured by the first open end (31) of the vertical measuring tube (30). It is learned that the air flow measurement device of the present invention is able to maximize the air pressure difference at two different positions, for example in this embodiment the second open ends (32,42), so that the oxygen providing machine is able to instantly make the adjustment of oxygen providing volume.

Also, it is noted that the air passages (21) smoothen the air flow passing through the air passages (21) such that the air flow has little influence by the laminar effect.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An air flow measurement device comprising:
a hollow cylindrical tube;
an air pipe securely formed inside the cylindrical tube;
a first measuring tube securely formed inside the cylindrical tube and having a first open end located at an inner side face of the air pipe so as to measure radial pressure of air flowing through the air pipe and a second open end extending out of the cylindrical tube; and
an L shaped measuring tube securely formed inside the cylindrical tube and having a first open end located at the inner side face of the air pipe so as to measure axial pressure of air flowing through the air pipe and a second open end extending directly downward and out of the cylindrical tube.

2. The air flow measurement device as claimed in claim 1, wherein the air pipe has multiple air passages formed inside the air pipe, the first open end of the first measuring tube is vertical to the air passages and the first open end of the L shaped measuring tube is parallel to the air passages.

3. The air flow measurement device as claimed in claim 1, wherein the first open end of the first measuring tube is located before the air passages and the first open end of the L shaped measuring tube is located after the air passages so that air pressure difference from the first measuring tube and the L shaped measuring tube is maximize and air flow passing through the air passages is smoothened.

4. The air flow measurement device as claimed in claim 2, wherein the first open end of the first measuring tube is located before the air passages and the first open end of the L shaped measuring tube is located after the air passages so that air pressure difference from the first measuring tube and the L shaped measuring tube is maximize and air flow passing through the air passages is smoothened.

4. An air flow measurement device comprising:
a hollow cylindrical tube;
an air pipe securely formed inside the cylindrical tube;
a first measuring tube securely formed inside the cylindrical tube and having a first open end located at an inner side face of the air pipe so as to measure radial pressure of air flowing through the air pipe and a second open end extending out of the cylindrical tube; and
two L shaped measuring tubes securely formed inside the cylindrical tube and each having a first open end located at the inner side face of the air pipe so as to measure axial pressure of air flowing through the air pipe and a second open end extending directly downward and out of the cylindrical tube.

5. The air flow measurement device as claimed in claim 4, wherein the air pipe has multiple air passages formed inside the air pipe, the first open end of the first measuring tube is vertical to the air passages and the first open end of the L shaped measuring tube is parallel to the air passages.

6. The air flow measurement device as claimed in claim 4, wherein the first open end of the first measuring tube is located before the air passages and the first open end of the L shaped measuring tube is located after the air passages so that air pressure difference from the first measuring tube and the L shaped measuring tube is maximize and air flow passing through the air passages is smoothened.

7. The air flow measurement device as claimed in claim 5, wherein the first open end of the first measuring tube is located before the air passages and the first open end of the L shaped measuring tube is located after the air passages so that air pressure difference from the first measuring tube and the L shaped measuring tube is maximize and air flow passing through the air passages is smoothened.
